(19) United States
(12) Patent Application Publication
(10) Pub. No.: US 2021/0298520 A1
(43) Pub. Date: Sep. 30, 2021

(54) Grill Rotating Assembly

(71) Applicant: Rennie West, Carson, CA (US)

(72) Inventor: Rennie West, Carson, CA (US)

(21) Appl. No.: 17/218,923

(22) Filed: Mar. 31, 2021

Related U.S. Application Data
(60) Provisional application No. 63/003,114, filed on Mar. 31, 2020.

(51) Int. Cl. A47J 37/04; A47J 37/07

(52) U.S. Cl. CPC A47J 37/041; A47J 2037/0795; A47J 37/0704; A47J 37/0786

(57) ABSTRACT

A grill assembly for rotating food on a grill in a single motion. The grill assembly includes a top and bottom rack that form an interior space to receive food. The racks include a handle to rotate the racks from a first side to a second side to cook each side of the food. A security bar extends from the rack to prevent the assembly from falling into the grill during operation. The racks include a series of wire members that form apertures to allow thermal energy from a heat source, such as a grill, to cook the food. The racks are supported on a stand that can be positioned on the grill. The stand includes a support arm having a groove that receives the racks thereon, and an adjustable support leg that allows for the user to adjust the height position of the racks when disposed thereon.

### CROSS REFERENCE TO RELATED APPLICATION

This application claims the benefit of U.S. Provisional Application No. 63/003,114 filed on Mar. 31, 2020. The above identified patent application is herein incorporated by reference in their entirety.

### BACKGROUND OF THE INVENTION

The present invention relates to a grill rotating assembly. The grill rotating assembly provides a device that safely accommodates food for cooking of a first side and subsequently allows for flipping to a second side. The grill rotating assembly comprises a top rack and a bottom rack arranged in a stacked configuration forming an interior space therebetween. The interior space is adapted to securely receive and retain food between the top and bottom racks. Apertures in the racks allow thermal energy from a heat source, such as a grill, to cook the food while in use. A handle extending from the racks allows a user to rotate the racks with a single motion to cook both the first and second side of the food without having the remove the food from the racks.

Typically, when a person is cooking a sliced vegetables or multiple fillets of meat or fish, the person is required to periodically turn the food so that it can cook evenly on both sides. This act can be performed with a spatula or fork. However, both common methods of using a spatula or fork are problematic. First, use of a spatula requires positioning the spatula underneath the food and causing the food to be flipped within the grate. This flipping action creates a risk of losing the food between the slats of a grill or falling off of the grill. Second, use of a fork to pierce the food does not provide sufficient distance between the hot grill surface and the hand of the cooker to safely operate. Moreover, when the fork is pierced into the food, the food may slip from the fork during the flipping operation causing the food to slip into grill.

Some specialized cooking implements for manipulating and turning food during the cooking process exist. For example, some rotisserie assemblies include a motor that continuously rotates an open rack over a heat source, such as a fire. However, these specialized cooking implements are not suitable for most cooking arrangements. Therefore, there exists a need for a grill rotating assembly that securely receives food between racks and allows a user to flip the assembly and secured food simultaneously without endangering the user with exposure from the heat source.

In light of the devices disclosed in the known art, it is submitted that the present invention substantially diverges in design elements and methods from the known art and consequently it is clear that there is a need in the art for an improvement for a grill rotating assembly. In this regard the instant invention substantially fulfills these needs.

### SUMMARY OF THE INVENTION

In view of the foregoing disadvantages inherent in the known types of grill rotating assemblies now present in the known art, the present invention provides a new grill rotating assembly wherein the same can be utilized for cooking food over a heat source and turning the assembly to cook both sides of the food.

It is an objective of the present invention to provide a grill rotating assembly comprising a top rack and a bottom rack in a stacked arrangement forming an interior space therebetween. The interior space is adapted to receive food such that the food remains between the top and bottom rack on a food receiving face of each rack.

It is another objective of the present invention to provide a grill rotating assembly wherein each rack comprises apertures that allow thermal energy from a heat source, such as grill, to pass therethrough.

It is yet another objective of the present invention to provide a grill rotating assembly wherein the top and bottom racks are disposed in a stacked arrangement such that the top and bottom racks are disposed on parallel, horizontal planes.

It is also an objective of the present invention to provide a grill rotating assembly comprising a security clip that secures the top and bottom racks such that the interior volume is selectively accessible, such that food is positioned between the bottom rack and the top rack.

It is yet another objective of the present invention to provide a grill rotating assembly comprising a handle affixed to the grill rotating assembly, wherein the handle is adapted to rotate the racks so as to cooperatively rotate both the top and bottom racks about a horizontal axis. In this way, the opposing sides of food positioned within the interior space are exposed to the thermal heat.

It is therefore an object of the present invention to provide a new and improved grill rotating assembly that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of a top rack and a bottom rack of one embodiment of the grill rotating assembly.

FIG. 2A shows a close-up, side view of an embodiment of the grill rotating assembly with actuatable panel for detaching food from the food receiving face in a retracted position.

FIG. 2B shows a close-up, side view of an embodiment of the grill rotating assembly with actuatable panel for detaching food from the food receiving face in a deployed position.

FIG. 3 shows a side view of an embodiment of a stand of the grill rotating assembly.

FIG. 4 shows a perspective view of a stand of an embodiment of the grill rotating assembly.

FIG. 5 shows a perspective view of an embodiment of the grill rotating assembly in use.

FIG. 6 shows a perspective view of another embodiment of the grill rotating assembly in use.

### DETAILED DESCRIPTION OF THE INVENTION

Reference is made herein to the attached drawings. For the purposes of presenting a brief and clear description of the present invention, the preferred embodiment will be discussed as used for securing food between the top and bottom rack for cooking food on a grill. The figures are intended for representative purposes only and should not be considered to be limiting in any respect.

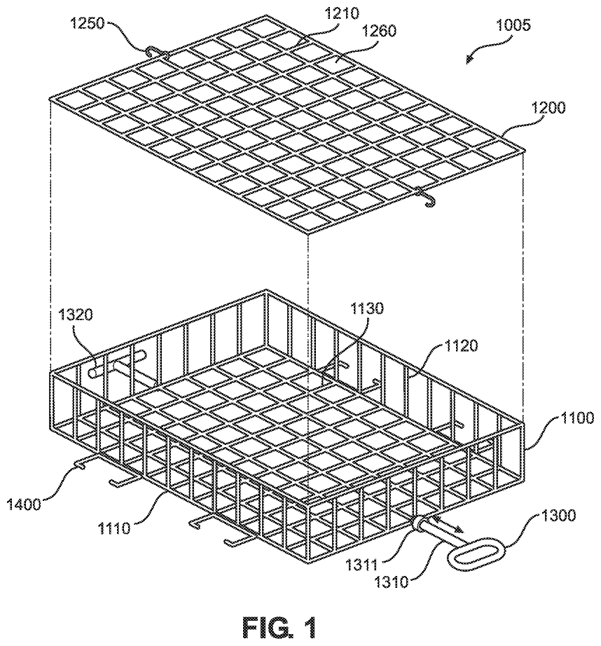

Referring now to FIG. 1, there is shown a perspective view of a top rack and a bottom rack of one embodiment of the grill rotating assembly. The grill rotating assembly 1000 provides a device for holding food positioned therein, and for cooking a first side for the food and flipping the grill flipping assembly to cook the opposing side. The grill flipping assembly comprises a first grill basket 1005 having a top rack 1200 and a bottom rack 1100 disposed in a stacked arrangement forming an interior space therebetween. Each rack 1100, 1200 comprises a food receiving face 1110, 1210 that is oriented towards the other rack and configured to receive the food thereon. In the shown embodiment, the racks 1100, 1200 are rectangular and have a similar geometry such that when they are in the stacked arrangement, the racks 1100, 1200 are generally coextensive. In the shown embodiment, the stacked arrangement of the top and bottom racks 1100, 1200 is disposed on parallel horizontal planes. In alternative embodiments, the racks may form any other shape.

In the illustrated embodiment, the bottom rack 1100 comprises a sidewall 1120 extending from the food receiving face 1110 and an open upper end. The top rack 1200 secures directly over the open upper end and to the sidewall of the bottom rack. The top rack 1200 is disposed on a single horizontal plane, which is the food receiving face 1210. In the illustrated embodiment, each rack includes apertures 1260 that allows thermal energy from a heat source, such as a grill, to pass therethrough and contact food positioned within the interior space. In the illustrated embodiment, the racks are composed of heat conductive material, such as metal wire, and disposed in a grid pattern in order to allow for uniform cooking of the food while in use. In one embodiment, the racks 1100, 1200 are composed of non-corrosive material such that the racks can be cleaned in the dishwasher without damage thereto.

In the illustrated embodiment, the bottom and top racks 1100, 1200 are operably connected at a first end via a fastener 1250, wherein the fastener 1250 is adapted to secure the bottom rack 1100 to the top rack 1200 such that the food is sandwiched therebetween. In the shown embodiment, the fastener 1250 is al-shaped hook that allows for the user to selectively adjust connect and disconnect the rack. The hook extends from a center of a first side and second side of the top rack 1200 and fasten around a perimeter wire of the bottom rack 1100. In other embodiments, any suitable fastener is contemplated that is configured to secure the top rack 1200 to the bottom rack 1100 in a stacked configuration.

In the illustrated embodiment, a handle 1300 is affixed to an end of the first grill basket 1005 and is adapted to cooperatively rotate both the top and bottom racks 1100, 1200 about a horizontal axis. In the shown embodiment, the handle 1300 extends outward from a center of a first side of the bottom rack 1100. The handle comprises a support arm 1310 extending from the grill basket and a ring-shaped hold configured to receive a hand therethrough. The horizontal axis is defined as extending along a length of the support arm 1310, from the bottom rack to the distal end of the handle 1300. The ring-shaped hold is disposed on a horizontal plane parallel to the plane of the top rack when secured to the bottom rack and adapted to provide a user a grip to cooperatively rotate both the top rack and the bottom rack about the horizontal axis. In the illustrated embodiment, the handle 1300 is fixed to the grill basket 1005. In one embodiment, the handle 1300 includes a hinge that provides for selective collapsing of the handle to a storage configuration. In one embodiment, the handle 1300 is completely separable from the bottom rack 1100.

In the illustrated embodiment, a security bar 1320 extends from a second side of the first grill basket 1005. In the illustrated embodiment, the security bar 1320 is T-shaped and is disposed on the bottom rack 1100 opposite the side wherein the handle 1300 is attached. The security bar 1320 comprises a support arm extending directly from the bottom rack 1100 and a horizontal bar that is adapted to prevent the first grill basket 1005 from being removed from along a longitudinal axis of a stand of the grill rotating assembly. The security bar 1320 is configured to support the grill rotating assembly 1000 in a stable position in order to prevent the assembly or portion thereof from slipping into the grill when flipping or otherwise operating. In the illustrated embodiment, a stopper 1311 is disposed around the support arm 1310 to also prevent the grill basket from being removed from along a longitudinal axis of a stand of the grill rotating assembly. The stopper 1311 is movable along the support arm 1310 to adjust to different sized grills. In the illustrated embodiment, the stopper 1310 comprises a ring shape.

In the illustrated embodiment, each rack 1100, 1200 is adjustable to accommodate different sized of food, such as steak, chicken, fish, vegetables and other food products. The bottom rack 1100 is adapted to be adjusted in height or length via telescopic wire members. In some embodiments, the sidewall 1120 of the bottom rack 1100 is composed of a pair of concentric, telescoping wires that selectively adjust when a user applies an upward force of the perimeter of the upper end of the bottom rack 1100. Both the top rack and bottom rack 1100, 1200 are adjustable in length to accommodate different sized grills.

In some embodiments, the grill rotating assembly 1000 comprises a plurality of grill baskets 1005, wherein each grill basket can comprise a different size relative to each other to accommodate different types and sizes of foods to be grilled. Each grill basket is securable to other via a C-shaped bracket 1400 that extends from a lateral side of the grill basket. In the illustrated embodiment, the bracket 1400 extends from the lateral side of the bottom rack 1100 and is adapted to secure to a lateral side of a bottom rack of a second grill basket. In this way, the grill rotating assembly 1000 is reconfigurable from a single grill basket to many arranged linearly.

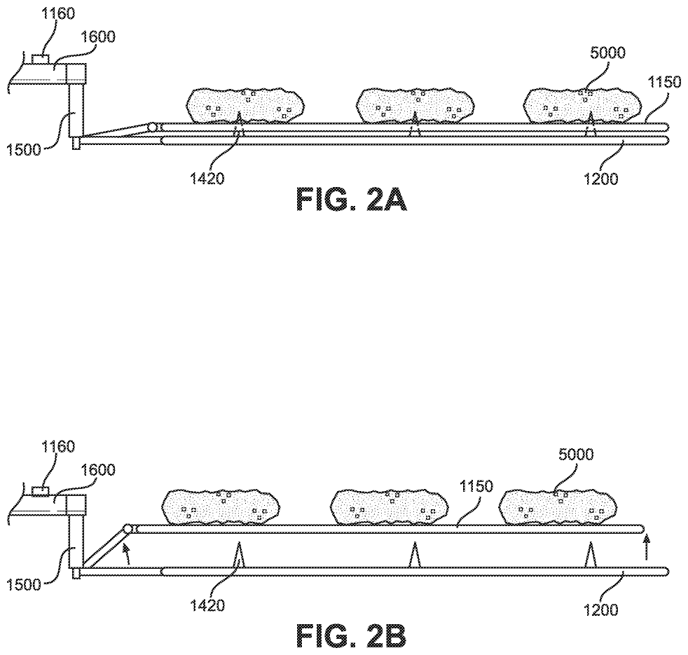

Referring now to FIGS. 2A and 2B, there is shown a close-up, side view of an embodiment of the grill rotating assembly with actuatable panel for detaching food from the food receiving face in a retracted and deployed position, respectively. In some embodiments, the food receiving face 1110 of the top or bottom rack comprise tines 1420 in order to puncture and secure food thereto. In the shown embodiment, an ejection panel 1150 is disposed on the food receiving face 1110 of the bottom rack 1100 and is configured to be positioned between the bottom rack and the food 5000 during use. The ejection panel 1150 is configured to remove or eject the food 5000 from the bottom rack 1100. In one embodiment, the ejection panel 1150 forms a grid pattern that corresponds with the arrangement of apertures and tines 1420, so as to allow the heat to contact the food 5000.

In some embodiments, the ejection panel 1150 is operably connected to a button or lever 1160 along the handle 1300, such that when actuated, the ejection panel 1150 is raised so as to force the food 5000 to be separated from the bottom rack 1100. In this way, the food 5000 does not stick to the racks 1100 during and after the cooking process. In one embodiment, the ejection panel 1150 includes nonstick material. In one embodiment, the first grill basket comprises an additional ejection panel 1150 on the top rack 1100 that acts to separate the food 5000 from both the racks 1100, 1200.

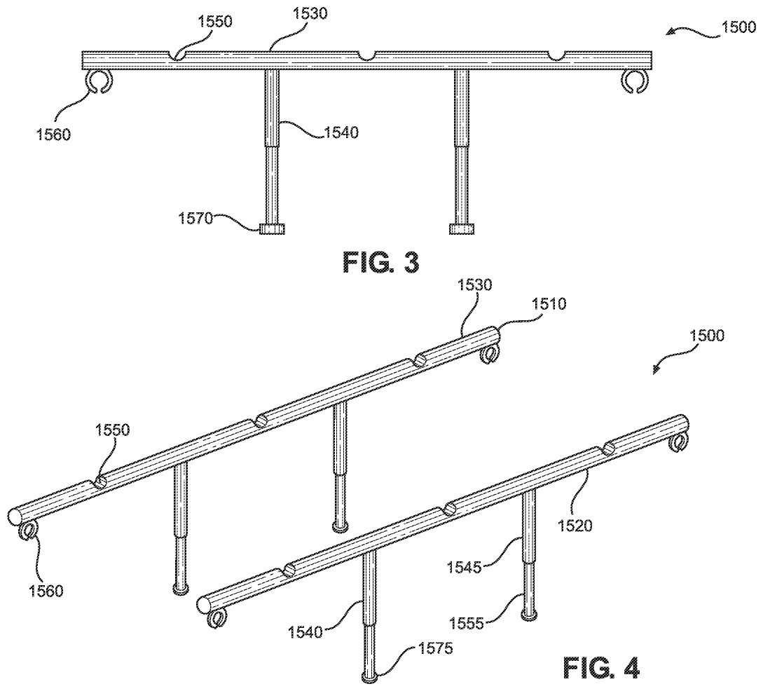

Referring now to FIGS. 3 and 4, there are shown side elevation view and a perspective view of an embodiment of a stand of the grill rotating assembly, respectively. In the illustrated embodiment, the grill rotating assembly comprises a stand 1500 having a horizontal support bar 1530 and one or more support legs 1540 extending from the horizontal bar 1530. The stand 1500 is adapted to support or suspend the grill basket above a grill grate. In the illustrated embodiment, the stand 1500 includes a first stand 1510 and a second stand 1520, wherein each stand is identical. The horizontal support bar 1530 comprises a first end and a second end, wherein each end includes a grill fastener 1560 adapted to secure to a sidewall of a grill. In the illustrated embodiment, the grill fastener 1560 is a C-shaped clamp having an opening at a lowermost end thereof. In some embodiments, the grill fastener 1560 extends above the support bar 1530, such as a hook, enabling the support bar 1530 to suspend downwards from the grill fastener 1560 to be positioned closer to the heat source. In the illustrated embodiment, there is no cross member connecting the pair of stands or horizontal support bars to one another. In other embodiments, the grill rotating assembly comprises at least one cross member connecting the first horizontal support bar to the second horizontal support bar.

The one or more support legs 1540 are adapted to vertically position the support bar 1530 and adjust the vertical position thereof. In the illustrated embodiment, each support leg 1540 is formed by at least two adjustable telescopic rods 1545, 1555. The rods 1545, 1555 are adapted to lock in place by any suitable locking mechanism, such as a friction fit or locking pin. In some embodiments, a support foot 1570 is disposed at the lowermost end of each support leg 1540 and adapted to rest flush against a grill surface to support the stand 1500 in an upright position. In some embodiments, the legs 1540 are rotatable or otherwise adjustable to accommodate different types of grill designs, such as grill bottoms with either horizontal or vertical slats.

Each support bar 1530 includes at least one groove 1550, wherein the illustrated embodiment, each support bar 1530 comprises a plurality of grooves 1550 disposed at intervals between the first and second end. Each groove 1550 on the first stand 1510 is adapted to align with a groove 1550 on the second stand 1520 such that each corresponding or aligned grooves 1550 are adapted to receive a grill basket therein. In this way, the racks are positioned semi-permanently on the stand. In the illustrated embodiment, the grooves 1550 comprise a semi-circular cross section configured to receive the support arm of the handle or security bar therein.

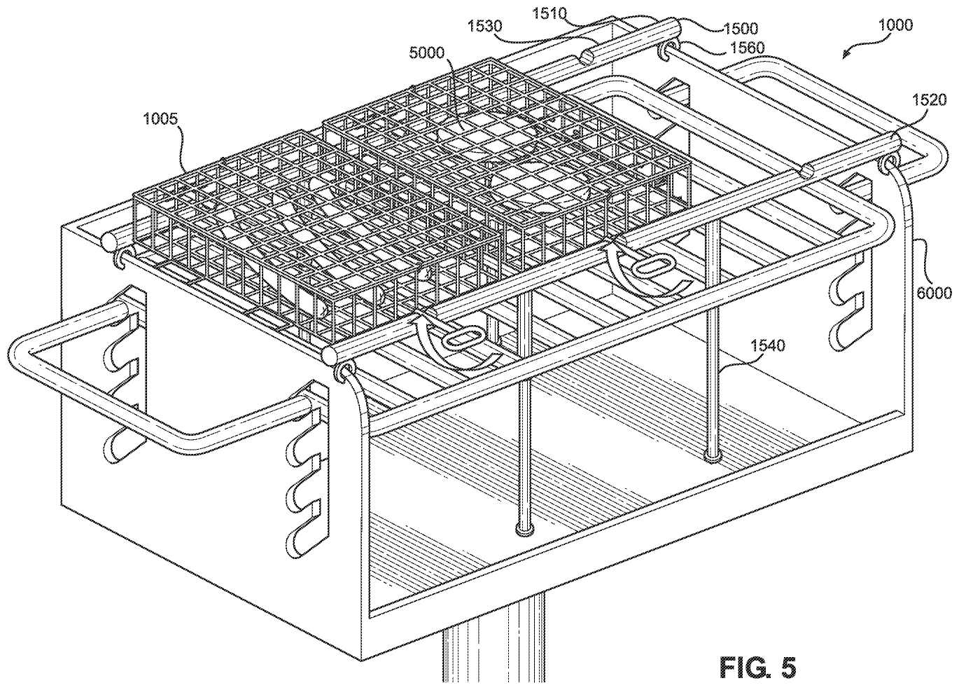

Referring now to FIG. 5, there is shown a perspective view of an embodiment of the grill rotating assembly in use. In operation, the first and second stands 1510, 1520 are placed within the grill 6000 to support the grill baskets. The height of the support bar is adjusted via the support legs 1540 to a desired distance from the heat source within the grill 6000. The grill fasteners 1560 of the stand 1500 are secured to the sidewall of the grill 6000. Food 5000 is positioned between the top and bottom racks so as to sandwich the food therebetween. The bottom rack is positioned within the grooves 1550 to prevent movement of the grill baskets thereacross. Once the food is secured between the racks, a user may reposition the grill baskets to be seated within any corresponding groove of the stand. To flip the basket, the user may rotate the handle about the horizontal axis without removing the handle and security bar from the respective grooves to expose the opposing side of the food to the heat source positioned below. Once the food is cooked for a desired time and/or temperature, the top and bottom racks are moved apart to extract the cooked food.

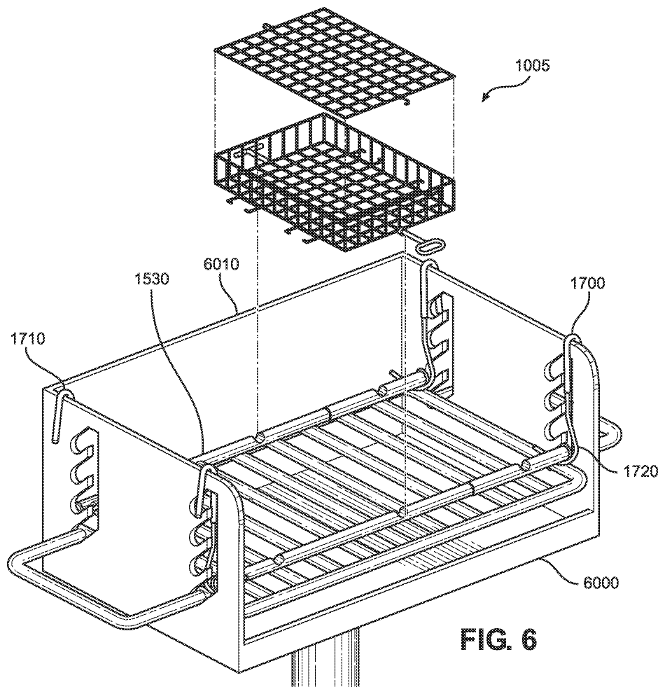

Referring now to FIG. 6, there is shown a perspective view of another embodiment of the grill rotating assembly in use. In some embodiments, at least one of the horizontal support bars 1530 is suspended from a grill fastener securable to a sidewall of the grill. In the illustrated embodiment, the grill fastener is a hook 1700. The hook 1700 comprises an upper end 1710 that secures over the upper end of the sidewall of the grill 6000 and a lower end 1720 that secures directly to the horizontal support bar 1530. The hooks 1700 are adapted to secure to the lateral sidewalls or the rear sidewall 6010 of the grill 6000. In the illustrated embodiment, the hooks are 1700 adjustable in length via a telescopic assembly of the upper end and lower end. In other embodiments, the hooks are adjustable by any suitable mechanism. The suspended grill fastener allows the grill basket 1005 to be positioned closer to the heat source and lower relative to the top end of the sidewall of the grill. In some embodiments, the hook is a 90 degree hook, wherein the upper end faces a different direction relative to the lower end. In other embodiments, the upper end and lower end of the hook are rotatable relative to one another to allow a user to selectively position the horizontal support bar along the lateral sidewall or rear sidewall of the grill.

In the illustrated embodiment, the horizontal support bars 1530 are adjustable in length via a pair of telescoping rods. The adjustability of the horizontal support bars allows the stand to fit on a variety of grills having different widths.

In some embodiments, the stand comprises a first horizontal support bar suspended from a fastening mechanism and a second horizontal support bar supported by a pair of support legs and a grill fastener. In this way, the stand accommodates grills having a sidewall with varying heights. higher back walls. Due to the adjustability of the hooks and support legs, the horizontal support bars are configured to be adjusted to accommodate the height of the grill plate and heat source of each grill.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A grill rotating assembly for supporting food over a heat source, comprising:
a first grill basket comprising a top rack removably secured to a bottom rack forming an interior space therebetween, wherein the interior space is adapted to receive food therein;
wherein the top and bottom racks each comprise a food receiving face oriented towards the other rack;
wherein each rack includes apertures to allow heat from the heat source to pass therethrough;
a handle extending from a first side of the bottom rack, wherein the handle is adapted to provide a user a grip to cooperatively rotate both the top rack and the bottom rack about a horizontal axis;
a security bar extending from a second side of the bottom rack;
a stand comprising a first and a second horizontal support bar each having a first end and a second end, wherein the first support bar comprises a first groove and the second support bar comprises a second groove;
wherein the first groove and second groove are adapted to align with each other to receive the handle and the security bar of the bottom rack to support the racks atop of the stand;
wherein the first end and a second end each comprise a grill fastener adapted to secure the stand to a sidewall of the grill.

2. The grill rotating assembly of claim 1, wherein the top rack and bottom rack are disposed in a stacked arrangement and in the stacked arrangement the top rack and the bottom rack are disposed on parallel horizontal planes.

3. The grill rotating assembly of claim 1, wherein the bottom rack and the top rack are operably connected via one or more fastening hooks extending from the top rack that removably couple to the bottom rack in the stacked configuration.

4. The grill rotating assembly of claim 1, further comprising a second grill basket that is securable to the first grill basket via one or more security clips extending from a sidewall of the bottom rack.

5. The grill rotating assembly of claim 1, wherein the bottom rack comprises a sidewall extending from the food receiving face and an open upper end that is removably covered by the top rack.

6. The grill rotating assembly of claim 1, wherein the top and bottom rack are independently adjustable in length via telescopic wire members.

7. The grill rotating assembly of claim 5, wherein the sidewall of the bottom rack is adjustable in height via telescopic wire members.

8. The grill rotating assembly of claim 1, wherein the handle comprises a support arm that is received in the first groove and a ring-shaped hold configured to receive a hand therethrough.

9. The grill rotating assembly of claim 1, wherein the security bar is T-shaped comprising a support arm that is received in the second groove and a horizontal bar adapted to prevent the first grill basket from being removed from the second groove along a longitudinal axis.

10. The grill rotating assembly of claim 1, wherein the stand comprises a second pair of aligned grooves adapted to receive a second grill basket.

11. The grill rotating assembly of claim 1, wherein the grill fastener is a c-shaped clamp extending from a lower side of the support bar such that an opening that receives the grill is disposed at a lowermost end of the grill fastener.

12. The grill rotating assembly of claim 1, a support leg extending perpendicular from each of the pairs of support bars and adapted to support the stand in an upright position.

13. The grill rotating assembly of claim 12, wherein the support leg is telescopic and comprises a heat-resistant foot at an end thereof for supporting the stand in an upright position.

14. The grill rotating assembly of claim 1, further comprising an ejection panel disposed on the food receiving face of the bottom rack and configured to release food from the bottom rack via actuation of a lever that causes the ejection panel to move away from the bottom rack and disengage food positioned thereon.

15. The grill rotating assembly of claim 14, wherein the bottom rack further comprises one or more tines adapted to puncture and secure food to the bottom rack.

16. The grill rotating assembly of claim 15, wherein the ejection panel forms a grid pattern that corresponds with the arrangement of apertures and tines.

17. The grill rotating assembly of claim 14, wherein the lever is positioned on the handle.

18. The grill rotating assembly of claim 1, wherein the grill fastener is a hook adapted to suspend the stand from the sidewall of the grill.

19. The grill rotating assembly of claim 18, wherein the hook is a 90 degree hook and adjustable in length along a longitudinal axis thereof.
